(19) United States
(12) Patent Application Publication
(10) Pub. No.: US 2006/0163064 A1
(43) Pub. Date: Jul. 27, 2006

(54) Sensor element for determining the concentration of a gas component in a gas mixture

(75) Inventors: Heiner Scheer, Berghuelen (DE); Harald Guenschel, Lisberg (DE); Lothar Diehl, Gerlingen (DE); Stefan Rodewald, Ditzingen (DE)

Correspondence Address: KENYON & KENYON LLP, ONE BROADWAY, NEW YORK, NY, 10004, US

(73) Assignee: Robert Bosch GmbH, Stuttgart (DE)

(21) Appl. No.: 10/519,117

(22) PCT Filed: Jul. 14, 2003
(86) PCT No.: PCT/DE03/02361

§ 371 Date: Dec. 22, 2004

(30) Foreign Application Priority Data
Aug. 1, 2002 (DE) 102 35 195.3

(51) Int. Cl. G01N 27/26

(52) U.S. Cl. 204/424

(57) ABSTRACT

A sensor element for determining the concentration of a gas component in a gas mixture, in particular for determining the concentration of oxygen in the exhaust gas of an internal combustion engine, having a laminated body that is made up of a plurality of solid electrolyte layers and that has an upper and a lower layer that are each fashioned as a film, as well as an intermediate layer. In order to simplify the manufacture and to reduce the manufacturing costs, the films of the upper and lower layer are fashioned with equal thicknesses, and the intermediate layer is applied as at least one printed layer of a film binder.

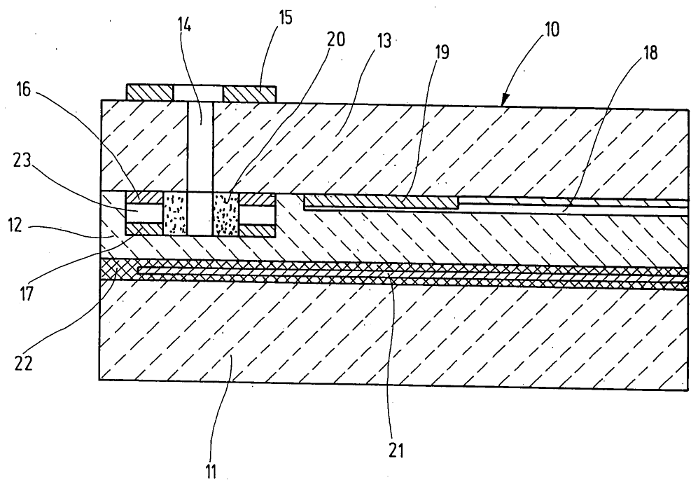

### FIELD OF THE INVENTION

The present invention is based on a sensor element for determining the concentration of a gas component in a gas mixture, in particular for determining the concentration of oxygen in the exhaust gas of an internal combustion engine.

### BACKGROUND INFORMATION

In a known sensor element of this type (German Patent Application No. DE 199 41 051), an upper, lower, and intermediate layer are cast as ceramic films of a solid electrolyte material that conducts oxygen ions, such as yttrium- stabilized zirconium oxide. A further solid electrolyte layer, situated between the upper and intermediate layers, is applied for example onto the upper layer by screen printing of a pastelike ceramic material. The material used for this is preferably the same as that of which the upper layer is made, thus e.g. zirconium oxide. In the plane (surface) of the additional solid electrolyte layer, there are situated functional layers, such as electrodes of a Nernst cell and a pump cell, and a reference duct. Between the lower and intermediate layers there is also situated an electrical resistance heater, embedded in an insulating layer of aluminum oxide. The integrated form of the planar ceramic laminated body is manufactured by laminating together the ceramic films (which are printed with the additional solid electrolyte layer and the functional layers) of the upper, lower, and intermediate layers, using film binders and subsequent sintering.

### SUMMARY OF THE INVENTION

The sensor element according to the present invention has the advantage that the inventive construction of the laminated body results in the omission of one film, and therewith of two film binder layers. The lamination layers of the laminated body are reduced from two lamination layers in the known sensor element, namely between the upper layer and the intermediate layer on the one hand and between the lower layer and the intermediate layer on the other hand, to only one lamination layer remaining between the lower and upper layer, thus reducing the probability of gas leaks in the lamination area and lowering the reject rate. Because the number of cast films significantly influences the production costs of the sensor element, these costs are also reduced by omitting a film. In addition, two additional printing steps are omitted for the application of the film binders for the intermediate layer, further reducing the manufacturing costs.

For the upper and lower layer, films having uniform thickness are used, so that in the manufacturing process only a single casting charge need be produced, so that the films have the same dry contraction (shrinkage), green contraction, and sintering contraction. The use of thicker films avoids handling problems, such as those that occur when screen printing is used to print the functional layers on thinner films. The film of the upper layer, which is thicker than that in the known sensor element, additionally provides the advantage that in the film, which is made mostly of zirconium oxide, the pumping of oxygen through the zirconium oxide has the result that fewer slight breakdowns, in the form of electrically conducting paths that could falsify the measurement signal, occur over the long-term, so that the serviceable life of the sensor element increases.

According to an advantageous specific embodiment of the present invention, the upper layer film contains a gas entry hole that completely penetrates through this film, and which is made in the film before the binding of the upper layer film to the laminated body. The provision of the gas entry hole in the upper layer film, which is not yet connected to the lower layer film, simplifies the manufacture of the gas entry hole, because the gas entry hole can be made by penetrating through the upper layer film, rather than having to maintain a defined boring depth in the laminated body, as is the case in the known sensor element.

### BRIEF DESCRIPTION OF THE DRAWING

The FIGURE shows a longitudinal section of a sensor element for determining the concentration of oxygen in the exhaust gas of an internal combustion engine, in a schematic representation.

### DETAILED DESCRIPTION

The sensor element for determining the concentration of oxygen in the exhaust gas of an internal combustion engine, shown schematically in longitudinal section in the Figure as an exemplary embodiment of a general sensor element for determining the concentration of a gas component in a gas mixture, has a laminated body 10 made up of a lower layer 11, an intermediate layer 12, and an upper layer 13. Here, lower layer 11 and upper layer 13 are cast ceramic films of a solid electrolyte material, preferably of yttrium-stabilized zirconium oxide (ZrO₂), while intermediate layer 12 is made of at least one film binder layer made of a solid electrolyte material that is printed on one of the films, for example on the film of upper layer 13, using screen printing. Zirconium oxide paste is preferably used for the film binder layer. A plurality of film binder layers are applied in successive printing steps.

The two films for upper and lower layer 13, 11 are constructed with the same thickness, and have a thickness between 0.3 mm and 1.0 mm, while the intermediate layer, made of one or more film binder layers, is made significantly thinner, its thickness being selected between 25 μm and 100 μm. In a preferred exemplary embodiment, the thickness of the two films for upper and lower layer 13, 11 is 0.5 mm in each case, and the thickness of intermediate layer 12 is 50 μm. In the film of upper layer 13 a gas entry hole 14 is made, e.g. stamped or bored, that completely penetrates the entire thickness of the film.

In a known manner, there is fashioned in laminated body 10 a pump cell made of a solid electrolyte and an inner and outer pump electrode, as well as a Nernst cell made of a solid electrolyte and a Nernst and reference electrode. The solid electrolyte of the pump cell is formed by upper layer 13, and the solid electrolyte of the Nernst cell is formed by intermediate layer 12. Outer pump electrode 15 and inner pump electrode 16 of the pump cell are each printed coaxially to the gas entry hole 15 on the upper or lower side of upper layer 13. Nernst electrode 17 of the Nernst cell is situated, together with pump electrode 16, in a hollow space 23 that is embedded in intermediate layer 12, while reference electrode 19 of the Nernst cell is situated in a reference gas duct 18 in intermediate layer 12. Reference gas duct 18, which can be charged with a reference gas in a known manner, can be filled with a porous material. Reference electrode 19 is printed, together with inner pump electrode 16, on the lower side of upper layer 13. Hollow space 23 is produced by a pore formation layer applied on intermediate layer 12 using a screen printing method. Inner pump electrode 16 and Nernst electrode 17, which is likewise situated coaxial to gas entry hole 14 and is axially at a distance from inner pump electrode 16, stand in connection in hollow space 23 with gas entry hole 14 via an annular diffusion barrier 20, so that outer pump electrode 15 can be charged directly with the exhaust gas of the internal combustion engine, and inner pump electrode 16, as well as Nernst electrode 17, can be charged with this gas via diffusion barrier 20. Between lower layer 11 and intermediate layer 12 there is situated an electrical resistance theater 21 that is embedded in an electrical insulating layer 22, made for example of aluminum oxide (Al₂O₃). Insulating layer 22 is printed on the upper side of lower layer 11. Laminated body 10 is manufactured by laminating together the ceramic films, printed with the film binder layers and the functional layers, and subsequent sintering of the laminated structure.

1-10. (canceled)

11. A sensor element for determining a concentration of a gas component in a gas mixture, comprising:
a laminated body including a plurality of solid electrolyte layers, the plurality of solid electrolyte layers including an upper layer, a lower layer and an intermediate layer, each of the upper and lower layers including a ceramic film, the upper and lower layers having an equal thickness, the intermediate layer including at least one film binder layer.

12. The sensor element according to claim 11, wherein the sensor element is for determining a concentration of oxygen in an exhaust gas of an internal combustion engine.

13. The sensor element according to claim 11, wherein the at least one film binder layer is printed on one of the films for the upper and lower layers.

14. The sensor element according to claim 11, wherein the at least one film binder layer is composed of a zirconium oxide paste.

15. The sensor element according to claim 11, wherein the thickness of the upper and lower layers is between 0.3 mm and 1.0 mm in each case, and a thickness of the intermediate layer is between 25 μm and 100 μm.

16. The sensor element according to claim 11, wherein the thickness of the upper and lower layers is 0.5 mm in each case, and a thickness of the intermediate layer is 50 μm.

17. The sensor element according to claim 11, wherein the upper layer includes a gas entry hole that completely penetrates the upper layer and that is made before a lamination of the laminated body.

18. The sensor element according to claim 17, further comprising, in the laminated body, a pump cell having an outer and inner pump electrode situated on a solid electrolyte, and a Nernst cell having a Nernst electrode and a reference electrode situated on a solid electrolyte, and wherein the upper layer forms the solid electrolyte of the pump cell and the intermediate layer forms the solid electrolyte of the Nernst cell.

19. The sensor element according to claim 18, further comprising a diffusion barrier for connecting the inner pump electrode and the Nernst electrode with the gas entry hole.

20. The sensor element according to claim 18, further comprising, in the intermediate layer, a reference gas duct that is charged with a reference gas, and that is in connection with the reference electrode, the reference gas duct being filled with porous material.

21. The sensor element according to claim 11, further comprising an electrical resistance heater embedded in an insulating layer and situated between the lower layer and the intermediate layer.
